(19) United States
(12) Patent Application Publication
(10) Pub. No.: US 2022/0355838 A1
(43) Pub. Date: Nov. 10, 2022

(54) METHOD, DEVICE AND RAIL VEHICLE

(71) Applicant: Siemens Mobility GmbH, Muenchen (DE)

(72) Inventor: Guenter Wolf, Nuernberg (DE)

(21) Appl. No.: 17/764,274

(22) PCT Filed: Sep. 11, 2020
(86) PCT No.: PCT/EP2020/075424

§ 371 Date: Mar. 28, 2022

(30) Foreign Application Priority Data
Sep. 26, 2019 (DE) 10 2019 214 707.0

(51) Int. Cl. B61L 15/00; G06V 20/59; G06V 10/24; G06V 10/764; G06V 10/44

(52) U.S. Cl. CPC B61L 15/0018; G06V 20/59; G06V 10/242; G06V 10/764; G06V 10/44

(57) ABSTRACT

A method for object monitoring of a rail vehicle using a video monitoring system includes capturing a measurement signal of a video camera and determining image data of an environment of a vehicle interior according to the captured measurement signal. A piece of luggage in the vehicle interior is identified according to the determined image data. The identified piece of luggage is personalized. A manipulation of the identified piece of luggage is determined according to a predefined manipulation condition. A notification signal is sent according to the determined manipulation and according to the personalizing of the identified piece of luggage. A device for operating a video monitoring system for a rail vehicle for object monitoring and a rail vehicle are also provided.

The invention relates to a method and a device for object monitoring by means of a video monitoring system for a rail vehicle. The invention furthermore relates to a rail vehicle comprising such a device.

Rail vehicles for conveying persons have monitoring systems used for example as digital video systems for recording a vehicle interior. Such a video system is generally linked to a data network in order to transmit the captured video signals. It is endeavored here to provide reliable video monitoring and to enable accurate supervision of the vehicle interior.

It is an object of the present invention to provide a method and a device for object monitoring by means of a video monitoring system for a rail vehicle which may contribute in each case to reliable video monitoring and to secure operation of the rail vehicle.

The object is achieved by a method and a device for object monitoring by means of a video monitoring system for a rail vehicle having the features of the respective independent patent claim, and by a rail vehicle comprising such a device. Advantageous configurations of the method are specified in the dependent patent claims.

In accordance with one aspect of the invention, a method for object monitoring by means of a video monitoring system for a rail vehicle to which a video camera is assigned comprises capturing a measurement signal of the video camera, which measurement signal is representative of image data of an environment of a vehicle interior of the rail vehicle, and determining image data of the environment of the vehicle interior depending on the captured measurement signal. The method furthermore comprises identifying a piece of luggage in the vehicle interior depending on the determined image data. The method furthermore comprises personalizing the identified piece of luggage. The method furthermore comprises determining a manipulation of the identified piece of luggage depending on a predefined manipulation condition. Moreover, the method comprises sending a notification signal depending on the determined manipulation and depending on the personalizing of the identified piece of luggage.

The method described makes it possible to realize reliable and personalized luggage monitoring in a vehicle interior of a rail vehicle. Such luggage monitoring is able to be carried out in particular by existing video monitoring systems that are usually installed in rail vehicles.

Such a video monitoring system comprises for example a digital video system for recording a vehicle interior of the rail vehicle, a so-called CCTV (closed circuit television) video monitoring installation. The video camera may thus also be referred to as a CCTV camera.

One insight in association with the present invention is that passengers in rail vehicles often stow their luggage in luggage carriers or luggage racks which are not directly visible from their seat. This leaves a feeling of insecurity with regard to possible theft of their luggage or vandalism thereof. By means of the method described, passengers can be warned in a targeted manner if their luggage is moved, for example, such that they can react in a timely manner and for example have a look to check up on their luggage.

The video monitoring system generally comprises a plurality of video cameras which observe a respective vehicle interior and in whose field of view or recording field luggage racks present are also captured. The vehicle interior is observed continuously, for example, and the captured image material is consulted and evaluated if, for example, a theft or vandalism has occurred or been recorded. On the basis of such an evaluation, it is then possible, if appropriate, to identify suspects and to enable prosecution. However, this does not enable prompt intervention with regard to an incident currently taking place, for example if a person takes a piece of luggage without authorization.

There is optionally the possibility of watching a current video recording on a screen provided. However, it would thus be necessary for a passenger to constantly observe the video recording or to access it often in order to make sure that an unauthorized access to his/her luggage is not taking place. By means of the method described, continuous observation of the video recording is not necessary and the passenger is made aware only when his/her luggage has been actually moved, displaced, taken away or opened, for example. This is effected by means of a personalized notification sent in particular to an assigned smartphone of the passenger.

In accordance with one preferred development of the method, personalizing the identified piece of luggage and sending a notification signal comprise assigning the identified piece of luggage to a mobile terminal that is capable of communicating with the video monitoring system in terms of signaling technology. Sending a notification signal is then effected depending on the assigning of the identified piece of luggage to the mobile terminal. The mobile terminal is realized in particular as a smartphone, cellular phone or tablet.

The notification signal can be sent to the assigned mobile terminal in particular in the form of an acoustic notification, a visual notification and/or a push notification. A notification can thus be issued as sound, as indication on the display and/or as vibration.

In accordance with one development of the method or of one of the developments described above, the predefined manipulation condition comprises a spatial threshold value that is representative of a permissible displacement of the identified piece of luggage. Determining a manipulation of the identified piece of luggage then comprises determining a displacement of the identified piece of luggage depending on measurement signals of the video camera and comparing the determined displacement with the predefined spatial threshold value. Sending a notification signal is then effected depending on the comparing of the determined displacement with the spatial threshold value. In this case, determining a displacement of the identified piece of luggage can comprise a translational movement or a rotation of the identified piece of luggage. By way of example, a tolerance value of 5-10 cm is predefined as the spatial threshold value, which value, when exceeded, results in the notification signal being sent to the smartphone. Alternatively, however, a threshold value of approximately 0 cm can also be predefined in order to interpret any movement as manipulation. A notification signal would be sent correspondingly frequently.

A spatial threshold value can for example also be predefined individually by the passenger and user of the smartphone. By way of example, the passenger would like to be made aware only if his/her luggage had been moved more than 30 cm. This also concerns for example resorting or reordering of the pieces of luggage in a luggage rack. For example, a passenger would like to reorder the already emplaced pieces of luggage so as to better utilize the available storage space and to be able to stow his/her own luggage. The passenger who has the already emplaced and identified piece of luggage is informed by means of the notification signal that his/her luggage has been moved.

The spatial threshold value can furthermore be representative of an opening movement of the identified piece of luggage, such that the method comprises determining an opening movement of the identified piece of luggage depending on measurement signals of the video camera. In accordance with such a development, comparing the determined opening movement with the predefined spatial threshold value is effected, and sending a notification signal is carried out depending on the comparing of the determined opening movement with the spatial threshold value. Such a development of the method takes account of the fact that the piece of luggage to be monitored need not necessarily be moved, but rather may also be opened without authorization in order, for example, to steal contents.

In accordance with one development of the method or of one of the developments described above, the predefined manipulation condition comprises a temporal threshold value that is representative of a permissible time duration with regard to concealment of the identified piece of luggage. Determining a manipulation of the identified piece of luggage then comprises determining a concealment of the identified piece of luggage and a concealment time duration depending on measurement signals of the video camera, and comparing the determined concealment time duration with the predefined time threshold value. Sending a notification signal is effected depending on the comparing of the concealment time duration with the time threshold value. In this way it is possible to take account of the circumstance that unrestricted monitoring of the piece of luggage is no longer possible on the basis of the image data of the video camera since, for example, a person is situated in front of the luggage rack for an unusually long time. For example, an elapsed time of 20 seconds as a temporal threshold value can trigger the sending of the alarm signal or the notification signal.

In accordance with one development of the method or of one of the developments described above, identifying the piece of luggage in the vehicle interior and determining a manipulation comprise detecting edges and/or capturing contours of an object, and classifying the object as a piece of luggage depending on the detecting of edges and/or the capturing of contours of the object. Such edge detection or the capturing of contours enables automated recognition of a piece of luggage.

Alternatively or additionally, automated recognition of a piece of luggage can be based on capturing an object in the vehicle interior depending on the determined image data. The captured object is compared with stored data comprising information about a positioned piece of luggage. Afterward, classifying the object as a piece of luggage is effected depending on the comparing of the captured object with the stored data. Such luggage recognition is carried out with the aid of a learning-based algorithm, for example. Such an algorithm can be trained by means of a multiplicity of different pieces of luggage that have been positioned differently in luggage racks, for example. In this way it is possible to reduce a number of false reports with regard to a purported manipulation of the piece of luggage to be monitored.

Recognizing or detecting a piece of luggage can be effected automatically and provide a preliminary selection, for example, which the passenger evaluates in order to select his/her piece of luggage. Alternatively, however, it is also possible for the passenger himself/herself to establish a digital frame or to predefine a region on the display of his/her smartphone which encompasses his/her piece of luggage and which is intended to be observed.

The described method and also the described developments of the method utilize in particular an existing video monitoring system of the rail vehicle for the personalized monitoring of luggage racks. An algorithm enables the automatic recognition of pieces of luggage. A passenger can dial into the video monitoring system for example wirelessly by means of his/her smartphone and select a video recording of the video monitoring system. The smartphone of the passenger and the video monitoring system of the rail vehicle are then capable of communicating with one another in terms of signaling technology. A preliminary selection of detected pieces of luggage can then be displayed on the display of the smartphone. The passenger can thereupon select the piece of luggage which he/she wants to be monitored. This is usually his/her piece of luggage. Such a selection is effected for example by marking by means of finger pressure on the display of the smartphone.

The video monitoring system of the rail vehicle is thus additionally utilized for monitoring the selected piece of luggage with regard to a possible manipulation. Such a manipulation can comprise concealment, movement, resorting, rotation, opening and/or removal of the piece of luggage. If such an activity is captured, the passenger is made aware of it by means of a notification signal. This can be effected for example by means of a so-called push notification on his/her smartphone. The passenger can thereupon dial or log into the video monitoring system and check what has triggered the notification and what is happening with his/her piece of luggage. In this case, by means of a correspondingly predefined manipulation condition, it is possible for example to take account of the circumstance that the piece of luggage to be monitored has only been displaced, and not stolen, in order to be able to stow further pieces of luggage in the luggage rack. In such a case, preferably no alarm signal is sent to the passenger's smartphone.

The method described thus enables reliable and convenient monitoring of a piece of luggage and personalized alerting of the passenger who wants the piece of luggage to be observed in an automated manner. The method can furthermore be utilized for informing the passenger on his/her smartphone that said passenger ought not to forget his/her piece of luggage when leaving the rail vehicle. Such a notification is preferably effected shortly before the planned alighting and is based for example on available electronic ticket information and/or an associated account of the traveler or passenger.

A further aspect of the invention relates to a device for operating a video monitoring system for a rail vehicle for object monitoring, which device is configured to carry out one of the methods described above. The device realizes for example a control or supervisory unit and is for example part of the video monitoring system. Alternatively, the device is for example a superordinate control device or a control unit of the rail vehicle which enables processing of signals and/or information of the video monitoring system.

Alternatively or additionally, a server unit external to the rail vehicle can be configured to carry out one of the methods described. The server unit and the rail vehicle are then capable of communicating with one another in terms of signaling technology.

In accordance with a further aspect, a rail vehicle comprises a vehicle body and a video monitoring system coupled to the vehicle body, wherein the video monitoring system is assigned to a vehicle interior of the vehicle body and has a video camera, in the field of view of which a luggage rack is observable. The rail vehicle furthermore comprises a configuration of the device described above which is capable of carrying out a method for operating the video monitoring system. The device is coupled to the video camera in terms of signaling technology.

By virtue of the fact that the device is designed to carry out one of the above-described methods for operating the video monitoring system for object monitoring, described properties and features of the method are also disclosed for the device and for the rail vehicle, and vice versa. The method described is able to be carried out beneficially in particular for reliable luggage monitoring in a rail vehicle, but can for example also be used for monitoring a cloakroom in a restaurant or some other publicly accessible location to which a video camera is assigned, the video recording of which is viewable by means of a mobile terminal.

The above-mentioned properties, features and advantages of the invention and the way in which they are achieved will be explained more extensively by the following description of the exemplary embodiments of the invention in conjunction with the corresponding figures, in which:

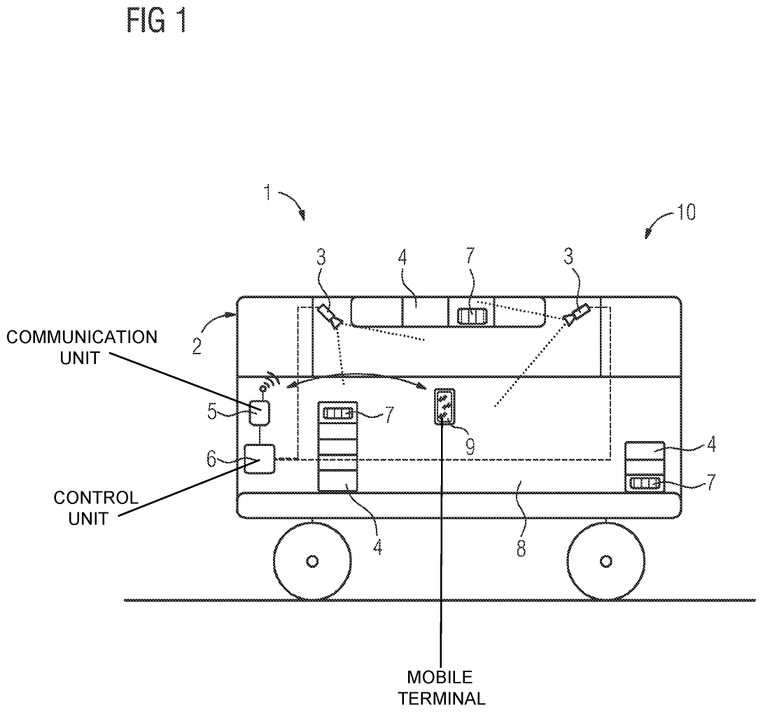

FIG. 1 shows a schematic illustration of a rail vehicle with a video monitoring system,

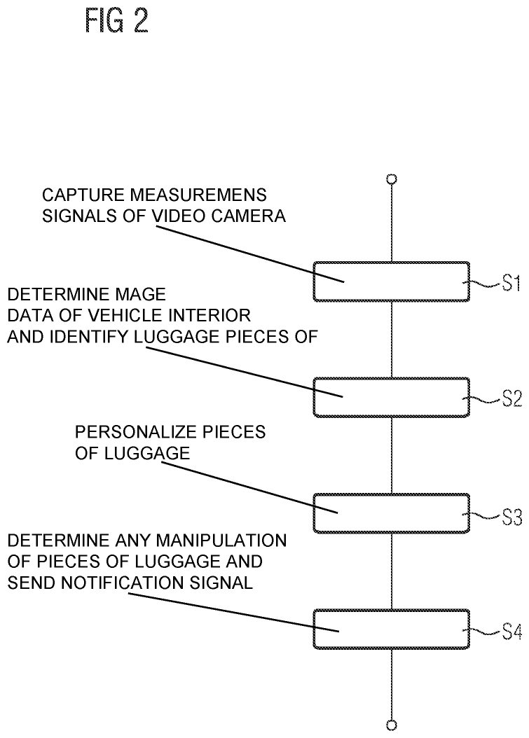

FIG. 2 shows a flow diagram for a method for operating the video monitoring system for object monitoring.

FIG. 1 shows, in a schematic side view, a rail vehicle 1 with a video monitoring system 10 comprising two video cameras 3. The video monitoring system 10 is assigned to a vehicle interior 8 of a vehicle body 2 of the rail vehicle 1 and enables observation of the vehicle interior 8 and monitoring of luggage situated therein. For example, a plurality of luggage racks 4 are provided in the vehicle interior 8 and enable pieces of luggage 7 to be stowed. The video cameras 3 and the luggage racks 7 are usually oriented such that the luggage racks 7 are arranged in the field of view of the video cameras 3 or the recording region of the video cameras 3 encompasses one or more luggage racks 7.

The video monitoring system 10 is realized as a CCTV monitoring system, for example, which represents a self-contained video monitoring installation. A control unit 6 is coupled to the video cameras 3 in terms of signaling technology and is configured to operate the video monitoring system 10. Furthermore, the control unit 6 is coupled to a communication unit 5, which enables the video monitoring system 10 to communicate wirelessly with a mobile terminal 9 in terms of signaling technology.

As explained below, a method enables reliable and personalized luggage monitoring in the vehicle interior 8 of the rail vehicle 1 by means of the video monitoring system 10. Such a method for object monitoring can be carried out in accordance with the flow diagram shown in FIG. 2. A step S1 involves capturing measurement signals of a video camera 3 that are representative of image data of an environment of the vehicle interior 8 of the rail vehicle 1 within which a luggage rack 4 is also arranged.

A step S2 involves determining image data of the environment of the vehicle interior 8 depending on the captured measurement signal and identifying a piece of luggage 7 in the vehicle interior 8 depending on the determined image data. The identified piece of luggage 7 is provided for personalization.

Personalizing the piece of luggage 7 is effected in a further step S3 by for example a passenger in the rail vehicle 1 selecting the identified piece of luggage 7 by means of a mobile terminal 9. The mobile terminal is embodied in particular as a smartphone 9. The piece of luggage 7 to be monitored is thus assigned to and associated with the smartphone of a passenger.

In a further step S4, the fact of whether or not a manipulation of the identified piece of luggage 7 is present is determined on the basis of further image data of the video camera 3 and depending on a predefined manipulation condition. If a manipulation is recognized, then a notification signal is sent depending on the determined manipulation and depending on the personalizing of the identified piece of luggage 7. The notification signal is issued for example as acoustic sound, as visual indication on the display and/or as vibration of the smartphone of the passenger.

The method described enables personalized monitoring of luggage racks 4 by means of the video monitoring system 10 of the rail vehicle 1. An algorithm enables automatic recognition of pieces of luggage 7. A passenger can dial into the video monitoring system 10 for example wirelessly by means of his/her smartphone and follow a video recording of the video monitoring system. A preliminary selection of detected pieces of luggage 7 can be displayed on the display of the smartphone and the passenger can select the piece of luggage 7 to be monitored.

The video monitoring system 10 of the rail vehicle 1 is thus utilized for monitoring the selected piece of luggage 7 with regard to a possible manipulation. Such a manipulation can comprise concealment, movement, resorting, rotation and/or opening of the piece of luggage and can be determined by comparing with a corresponding manipulation condition. For example, a spatial threshold value is predefined which allows a tolerable movement of the piece of luggage 7. In the event of the spatial threshold value being exceeded, a manipulation is determined and the associated passenger is made aware of that by a notification signal.

The passenger can thereupon log into the video monitoring system 10 and check the current video recording with the luggage rack 4 situated therein. The passenger can thus check what triggered the notification and what is happening with his/her piece of luggage 7.

The method described thus enables reliable, convenient and automated monitoring of a respective piece of luggage 7 and personalized alerting of the passenger associated with the piece of luggage 7.

Although the invention has been illustrated and described in detail on the basis of exemplary embodiments, the invention is not restricted to the exemplary embodiments disclosed and the concrete feature combinations explained therein. Further variations of the invention can be obtained by a person skilled in the art, without departing from the scope of protection of the claimed invention.

### LIST OF REFERENCE SIGNS

1 Rail vehicle
2 Vehicle body of the rail vehicle
3 Video camera
4 Luggage rack
5 Communication unit of the rail vehicle
6 Control unit of the rail vehicle
7 Piece of luggage
8 Vehicle interior of the rail vehicle
9 Mobile terminal/smartphone
10 Video monitoring system
S(i) Step of a method for operating a video monitoring system for the rail vehicle

1-11. (canceled)

12. A method for object monitoring of a rail vehicle using a video monitoring system having a video camera, the method comprising:
capturing a measurement signal of the video camera, the measurement signal being representative of image data of an environment of a vehicle interior of the rail vehicle;
determining image data of the environment of the vehicle interior in dependence on the captured measurement signal;
identifying a piece of luggage in the vehicle interior in dependence on the determined image data;
personalizing the identified piece of luggage;
determining a manipulation of the identified piece of luggage in dependence on a predefined manipulation condition; and
sending a notification signal in dependence on the determined manipulation and in dependence on the personalizing of the identified piece of luggage.

13. The method according to claim 12, which further comprises carrying out the personalizing of the identified piece of luggage and the sending of the notification signal by:
assigning the identified piece of luggage to a mobile terminal being capable of communicating with the video monitoring system in terms of signaling technology; and
sending a notification signal in dependence on the assigning of the identified piece of luggage to the mobile terminal.

14. The method according to claim 13, which further comprises sending the notification signal to the assigned mobile terminal as at least one of an acoustic notification, a visual notification or a push notification.

15. The method according to claim 12, which further comprises providing the predefined manipulation condition as a spatial threshold value being representative of a permissible displacement of the identified piece of luggage, and carrying out the determining of the manipulation of the identified piece of luggage by:
determining a displacement of the identified piece of luggage in dependence on measurement signals of the video camera;
comparing the determined displacement with the predefined spatial threshold value; and
sending a notification signal in dependence on the comparing of the determined displacement with the spatial threshold value.

16. The method according to claim 15, which further comprises carrying out the determining of the displacement of the identified piece of luggage by determining a rotation of the identified piece of luggage.

17. The method according to claim 12, which further comprises providing the predefined manipulation condition as a spatial threshold value being representative of an opening movement of the identified piece of luggage, and carrying out the determining of the manipulation of the identified piece of luggage by:
determining an opening movement of the identified piece of luggage in dependence on measurement signals of the video camera;
comparing the determined opening movement with the predefined spatial threshold value; and
sending the notification signal in dependence on the comparing of the determined opening movement with the spatial threshold value.

18. The method according to claim 12, which further comprises providing the predefined manipulation condition as a temporal threshold value being representative of a permissible time duration with regard to concealment of the identified piece of luggage, and carrying out the determining of the manipulation of the identified piece of luggage by:
determining a concealment of the identified piece of luggage and a concealment time duration in dependence on measurement signals of the video camera;
comparing the determined concealment time duration with the predefined time threshold value; and
sending the notification signal in dependence on the comparing of the concealment time duration with the time threshold value.

19. The method according to claim 12, which further comprises carrying out the identifying of the piece of luggage in the vehicle interior and determining the manipulation by:
at least one of detecting edges or capturing contours of an object; and
classifying the object as a piece of luggage in dependence on the at least one of detecting edges or capturing contours of the object.

20. The method according to claim 12, which further comprises carrying out the identifying of the piece of luggage in the vehicle interior and determining the manipulation by:
capturing an object in the vehicle interior in dependence on the determined image data;
comparing the captured object with stored data including information about a positioned piece of luggage; and
classifying the object as a piece of luggage in dependence on the comparing of the captured object with the stored data.

21. A device for operating a video monitoring system for a rail vehicle for object monitoring, the device configured to carry out the method according to claim 12.

22. A rail vehicle, comprising:
a vehicle body;
a video monitoring system coupled to said vehicle body and having a video camera assigned to a vehicle interior of the vehicle body; and
a device according to claim 21 for operating said video monitoring system for object monitoring, said device being coupled to said video camera in terms of signaling technology.
